(19) United States
(12) Patent Application Publication
(10) Pub. No.: US 2023/0118735 A1
(43) Pub. Date: Apr. 20, 2023

(54) IN-VEHICLE NETWORK SYSTEM

(71) Applicant: Mitsubishi Electric Corporation, Tokyo (JP)

(72) Inventors: Hajime HASEGAWA, Tokyo (JP); Shigeki TSUJII, Tokyo (JP); Daisuke YASE, Tokyo (JP)

(73) Assignee: Mitsubishi Electric Corporation, Tokyo (JP)

(21) Appl. No.: 17/914,615

(22) PCT Filed: May 7, 2020
(86) PCT No.: PCT/JP2020/018507

§ 371 Date: Sep. 26, 2022

(51) Int. Cl. G06F 3/06

(52) U.S. Cl. CPC G06F 3/067; G06F 3/0604; G06F 3/0655

(57) ABSTRACT

An in-vehicle network system includes: sensors for acquiring information about a vehicle; actuators for controlling travel of the vehicle and interior environment thereof; an integrated controller unit for outputting control signals for controlling the actuators on the basis of data of the information acquired by the sensors; storage devices and a storage devices for storing the data of the information data acquired by the sensors and data of the control signals output from the integrated controller unit; and a storage controller for allocating and storing the data of the information acquired by the sensors and the data of the control signal output from the integrated controller unit to and in the storage devices and the storage devices. The storage controller generates parities corresponding to the allocated data and stores data of the parities in at least one of the storage devices, thus increasing survivability of the data.

### TECHNICAL FIELD

The present application relates to an in-vehicle network system.

### BACKGROUND ARTS

In recent years, in order to verify environmental information around a vehicle, vehicle recognition, and determination and statuses of operational actions when an accident occurs during automatic driving that needs no driver’s operation of the vehicle, it requires input/output data of the control ECU (electric control unit), the sensors, and the actuators. In-vehicle network systems have been known that communicate via relay ECUs between an integrated controller and a plurality of sensors, actuators and the likes provided in a vehicle, and an in-vehicle network system has been further proposed that additionally provided with a data recorder function. For example, Patent Document 1 discloses a low-cost data-collection in-vehicle network configured by narrowing down the number of storage devices, in which control ECUs are connected to lines dedicated to each function of a vehicle and a storage device is provided to a gateway ECU for relaying data communication on each line, thus enabling collection and transmission of signals from/to sensors and actuators through the in-vehicle network with high efficiency and high probability when an event occurs.

### PRIOR ART DOCUMENT

### Patent Document

Patent Document 1: JP5561186B (Paragraph [0041], FIG. 1)

### SUMMARY OF THE INVENTION

### Problem That The Invention Is to Solve

An in-vehicle network system for realizing automatic driving deals with a large amount of data output from a plurality of sensors, thus posing a problem of needing to select a storage device having a fast write speed. Moreover, losing the function of the gateway ECU having the storage device raises a problem of losing a significant amount of information collected and transmitted.

The present application is made to resolve problems such as described above and aimed at providing an in-vehicle network system that effectively collects statues of automatic driving operations and increases survivability of the collected information.

### Means for Solving The Problem

An in-vehicle network system disclosed in the present application includes sensors configured to acquire information about a vehicle; actuators configured to control travel of and interior environment of the vehicle; a control command unit configured to output control signals for controlling the actuators on the basis of data of the vehicle information acquired by the sensors; a plurality of storage devices configured to store the data of the vehicle information acquired by the sensors and data of the control signals output from the control command unit; and a storage controller configured to allocate and stores the data of the vehicle information and the data of the control signals to and in the plurality of storage devices, wherein the storage controller generates parities corresponding to the allocated data and stores data of the parities in at least one of the storage devices.

### Advantageous Effect of The Invention

According to the present invention, by allocating and storing vehicle information data and vehicle control signal data to and in a plurality of storage devices, even if any of these data is lost, the lost data can be restored, thus being able to increase survivability of the stored data.

### BRIEF DESCRIPTION OF THE DRAWINGS

FIG. 1 is a schematic diagram illustrating the configuration of an in-vehicle network system according to Embodiment 1;

FIG. 2 is a schematic diagram illustrating the state of communication between a management unit and the in-vehicle network system according to Embodiment 1;

FIG. 3 is a diagram showing an example of hardware of the in-vehicle network system according to Embodiment 1;

FIG. 4 is a diagram for explaining a data storage technique in the in-vehicle network system according to Embodiment 1;

FIG. 5 is a diagram for explaining another data storage technique in the in-vehicle network system according to Embodiment 1;

FIG. 6 is a diagram for explaining yet another data storage technique in the in-vehicle network system according to Embodiment 1;

FIG. 7 is a diagram for explaining still another data storage technique in the in-vehicle network system according to Embodiment 1; and

FIG. 8 is a flowchart showing an example of a data recorder function of the in-vehicle network system according to Embodiment 1.

### DETAILED DESCRIPTION OF THE INVENTION

### Embodiment 1

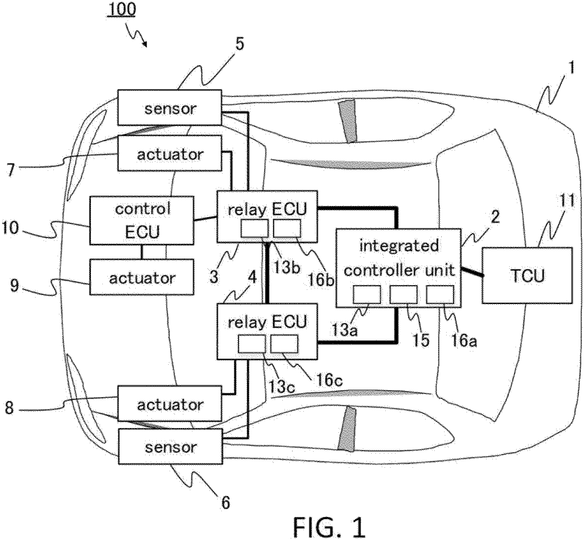

FIG. 1 is a schematic diagram illustrating the configuration of an in-vehicle network system according to Embodiment 1. Referring to FIG. 1, the in-vehicle network system 100 is a system that is mounted in a vehicle 1 and accumulates data input to and output from sensors, control ECUs, and actuators installed in the vehicle 1 to support detailed analysis of the situation around and the status of the vehicle when an event occurs. The in-vehicle network system 100 includes in the vehicle 1 an integrated controller unit 2 as a control command unit and relay ECUs 3, 4 as relay units and connects them to each other through a backbone network capable of high-speed communication, such as for example an Ethernet®.

The integrated controller unit 2 receives information data from sensors 5, 6 via the relay ECUs 3, 4 to grasp environment around the vehicle 1 and the levels of driver’s operations, and gives operational commands to actuators 7, 8, 9. The integrated controller unit 2 is provided with, for example, a system on chip (SoC) and a volatile memory (DRAM) to manipulate the information data from each sensor to give the commands to the actuators. Moreover, the integrated controller unit 2 has a storage devices 13a for holding the information data received from each of the sensors 5, 6, the command data for the actuators 7, 8, 9, and software for the integrated controller unit 2 to execute. A non-volatile memory such as, for example, a flash memory is used for the storage devices 13a. Note that while one integrated controller unit 2 is provided in Embodiment 1, a plurality of integrated controller units may be connected to the backbone network for a case of requiring a sophisticated processing and redundancy in, for example, automatic driving with driver’s hands off or the like.

The relay ECUs 3, 4 are connected to the integrated controller unit 2 through the backbone network to send the information data acquired from the sensors 5, 6 to the integrated controller unit 2 and to send operational commands received from the integrated controller unit 2 to the actuators 7, 8 connected with the relay ECUs 3, 4 and to the actuator 9 via the control ECU 10 connected with the relay ECU 3. The relay ECUs 3, 4 have a routing function of sorting the operational commands sent from the integrated controller unit 2 to the actuators 7, 8 and the control ECU 10, respectively. Moreover, the relay ECUs 3, 4 have storage devices 13b, 13c, respectively, for holding information data received from each of the sensors 5, 6 and the command data for the actuators 7, 8, 9. A non-volatile memory such as, for example, a flash memory is used for the storage devices 13b, 13c. Note that while the two relay ECUs are provided in Embodiment 1, integrated controller units, actuators, and control ECUs in the vehicle are, for example, segmented on the area basis and relay ECUs may be provided for each area.

The relay ECUs 3, 4 and the integrated controller unit 2, actuators 7, 8, and the control ECU 10 are connected by communication lines that are formed in any one of a star connection, a loop connection, and a bus connection, or combination thereof. For example, in a case of the vehicle 1 having an automatic driving function, a malfunction due to a disconnection in the backbone communication is prevented by making dual redundant the loop connection or the star connection of the backbone communication line connecting between the relay ECUs 3, 4 and the integrated controller unit 2.

The sensors 5, 6 have functions such as of, for example, a radar, a camera, a thermosensor, a steering angle sensor, an accelerator pedal sensor, and a brake pedal sensor to grasp the surrounding environment of and the interior environment of the vehicle 1 and operations by the driver. Information data sensed by the sensors 5, 6 are sent to the relay ECUs 3, 4. Note that while the sensors 5, 6 are respectively connected only to the relay ECUs 3, 4 in Embodiment 1, the sensors may be connected not only to the relay ECUs 3, 4 but also to the control ECU 10 and the integrated controller unit 2.

The actuators 7, 8 have functions of driving and controlling operations of, for example, the steering motor, the engine equipment, the wiper motors, power window motors, and the like relating to travelling, curving, and stopping of the vehicle 1, and of driving and controlling the air-conditioner equipment and the like for making the interior environment comfortable. Note that the actuators 7, 8 may be connected to the control ECU 10 or the integrated controller unit 2 as with the actuator 9.

The control ECU 10 is connected to the relay ECU 3 to drive the actuator 9 on the basis of a control command signal from the integrated controller unit 2. The control ECU 10 is provided with a microcomputer for transforming the control command signal from the integrated controller unit 2 into a waveform for driving the actuator 9. Note that while only one control ECU 10 is provided in Embodiment 1, a plurality of control ECUs may be provided. Moreover, the control ECU 10 may be connected not only to the relay ECU 3 but also to the integrated controller unit 2.

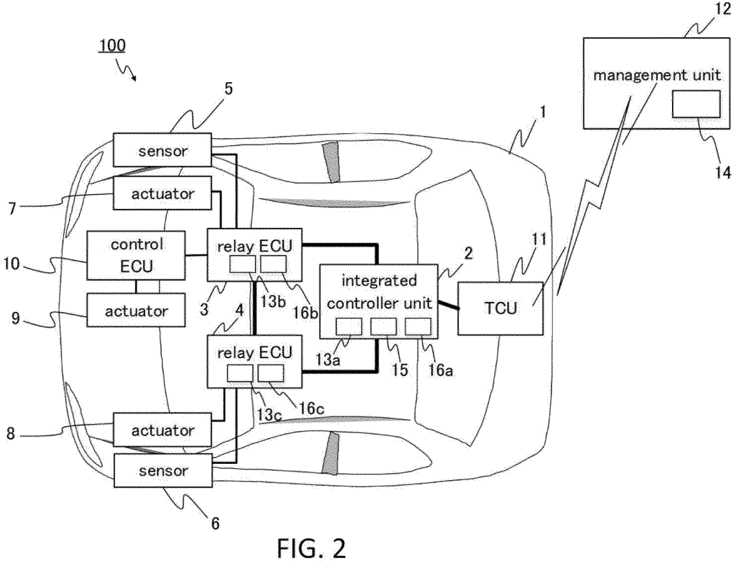

FIG. 2 is a schematic diagram illustrating a state of communication between a management unit 12 and the in-vehicle network system 100 according to Embodiment 1. The in-vehicle network system has a telematics control unit (TCU) 11 connected to the integrated controller unit 2. The TCU 11 is provided with a radio frequency (RF) circuit to perform telecommunication.

As shown in FIG. 2, the management unit 12 is configured to be connected to the TCU 11 through telecommunication to manage the vehicle 1. Moreover, the management unit 12 has a storage devices 14 for holding data received from the TCU 11 of the vehicle 1.

The integrated controller unit 2 is provided with a storage controller 15 for identifying items of and setting a writing period of data to be accumulated in the storage devices 13a, 13b, 13c and/or the storage devices 14 and for deleting and overwriting data accumulated therein. In the case of the network system having both of the storage devices 13a, 13b, 13c and the storage devices 14 as in Embodiment 1, the integrated controller unit 2 may be provided in any one of or both of the vehicle 1 and the management unit 12. Although it is more efficient to provide such storage controllers 15 in the relay ECUs 3, 4 and the integrated controller 2 to each of which data are gathered, the storage controller(s) 15 may be provided in, for example, any one of or both of the integrated controller 2 and the relay ECUs 3, 4. While one integrated controller unit and one ECU usually perform communication for control between the vehicle 1 and the management unit 12, priority for the storage controllers may be determined, for example, depending on the amount of collected data in a case of a plurality of storage controllers 15 being provided in the integrated controller unit 2 and the relay ECUs 3, 4.

The storage controller 15 monitors the traffic on the backbone communication line and changes each cycle for storing data in the storage devices 13a, 13b, 13c and/or the storage devices 14 to ensure real-time performance in controlling the vehicle 1. Moreover, data to be stored is prioritized beforehand. When communication speed of the backbone communication line is decreased at a moment of occurrence of an event, only prioritized data is stored in the storage devices 13a, 13b, 13c and/or the storage devices 14 to keep the traffic normal.

The integrated controller unit 2, the relay ECUs 3, 4, and the management unit 12 have respective difference extraction functions 16a, 16b, 16c, 16d for extracting differences in data received from each of the sensors 5, 6 and in command data for each of the actuators 7, 8, 9 and the control ECU 10. In addition, such a difference extraction function may be implemented only in hardware incorporating the storage controller 15.

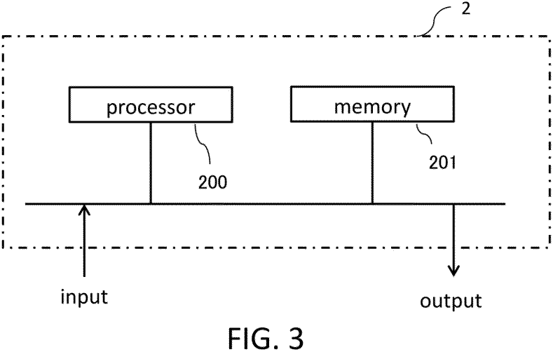

The integrated controller unit 2 includes a processor 200 and a memory 201 as shown by an example of the hardware of FIG. 3. The memory, although not specifically shown, is constituted with a volatile memory such as a random access memory and a non-volatile auxiliary memory such as a flash memory. In addition, the memory may be constituted with a hard disk as the auxiliary memory instead of the flash memory. The processor 200 executes a program input from the memory 201. At this time, the program is input to the processor 200 from the auxiliary memory via the volatile memory. The processor 200 may output data such as a computed result to the volatile memory of the memory 201 or may store the data in the non-volatile auxiliary memory via the volatile memory.

### EXAMPLES

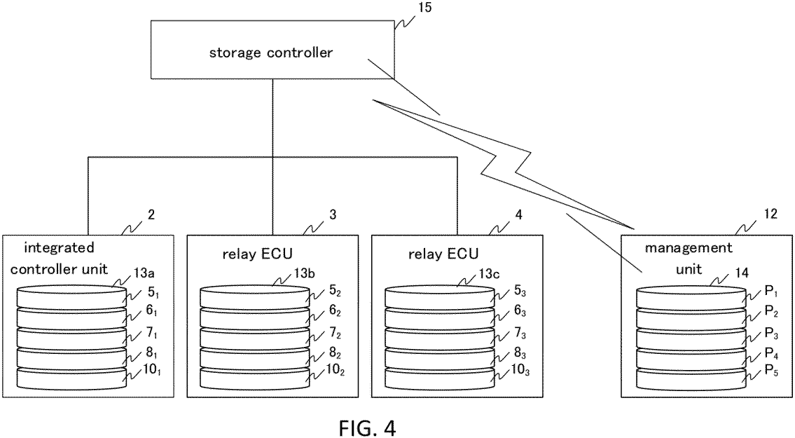

Next, data storage techniques in the in-vehicle network system according to Embodiment 1 are described specifically. FIGS. 4 to 6 are diagrams for explaining the data storage techniques in the in-vehicle network system according to Embodiment 1. In FIGS. 4 to 6, a case of using both of the storage devices 13a, 13b, 13c and the storage devices 14 shown in FIG. 2 is described. In a case of no storage devices 14, using any one of the storage devices 13a, 13b, 13c instead of the storage devices 14 enables a similar storage operation.

The storage controller 15 allocates data to be written to the storage devices 13a, 13b, 13c and/or the storage devices 14, and generates an error correction code (parity) to store them in any of the storage devices 13a, 13b, 13c and the storage devices 14. It is a known technique that when part of data lost, the data can be restored by combining their parities and the remaining data.

### Example 1

FIG. 4 shows a data storage technique of Example 1. The storage controller 15 allocates the information data from the sensors 5, 6 and the control signal data for the actuators 7, 8 and the control ECU 10 to storage locations and generates their parities. In a case of the number of storage locations being n, the information data from the sensors 5, 6 and the control signal data for the actuators 7, 8 and the control ECU 10 each are divided into n-1 pieces, and values generated by XORing the divided pieces of the data are defined as the parities. The number n of storage locations is four in Example 1 because four of the storage devices 13a, 13b, 13c and the storage devices 14 are provided. Accordingly, the information data from the sensor 5 is divided into three (= n-1) pieces and is written as divided information data pieces 5₁, 5₂, 5₃ in the storage devices 13a, 13b, 13c, respectively, as shown in FIG. 4. Divided pieces 6₁, 6₂, 6₃ of the information data from the sensor 6, divided pieces 7₁, 7₂, 7₃ of the control signal data for the actuator 7, divided pieces 8₁, 8₂, 8₃ of the control signal data for the actuator 8, and divided pieces 10₁, 10₂, 10₃ of the control signal data for the control ECU 10 are written also in the storage devices 13a, 13b, 13a, respectively. A parity P₁ that is generated by XORing the divided pieces 5₁, 5₂, 5₃ of the information data from the sensor 5 is written in the storage devices 14. Likewise, parities P₂, P₃, P₄, P₅ that are generated by respectively XORing the divided pieces 6₁, 6₂, 6₃ of the information data from the sensor 6, the divided pieces 7₁, 7₂, 7₃ of the control signal data for the actuator 7, the divided pieces 8₁, 8₂, 8₃ of the control signal data for the actuator 8, and the divided pieces 10₁, 10₂, 10₃ of the control signal data for the control ECU 10 are written also in the storage devices 14.

### Example 2

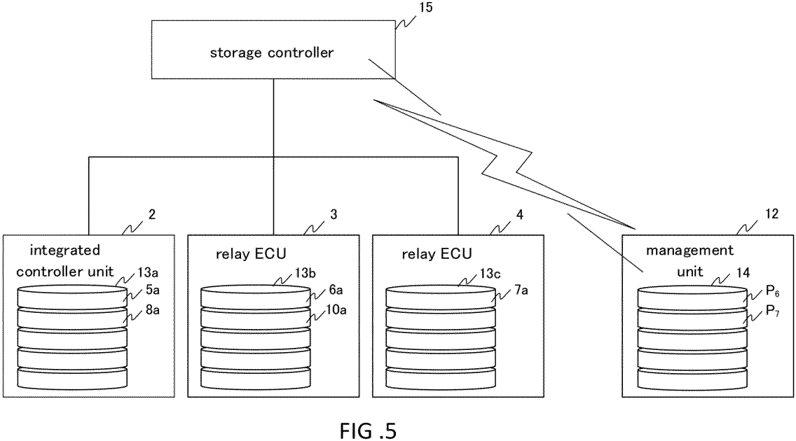

FIG. 5 shows a data storage technique of Example 2. The storage controller 15 allocates, on the data item basis, the information data from the sensors 5, 6 and the control signal data for the actuators 7, 8 and the control ECU 10 to storage locations and generates their parities. In Example 2, the whole information data 5a from the sensor 5 is written in the storage devices 13a, the whole information data 6a from the sensor 6 is written in the storage devices 13b, and the whole control signal data 7a for the actuator 7 is written in the storage devices 13c, as shown in FIG. 5. A parity P₆ that is generated by XORing the whole information data 5a from the sensor 5, the whole information data 6a from the sensor 6, and the whole control signal data 7a for the actuator 7 is written in the storage devices 14. Likewise, the whole control signal data 8a for the actuator 8 is written in the storage devices 13a, the whole control signal data 10a for the control ECU 10 is written in the storage devices 13b, and a parity P₇ that is generated by XORing the whole control signal data 8a for the actuator 8 and the whole control signal data 10a for the control ECU 10 is written in the storage devices 14.

### Example 3

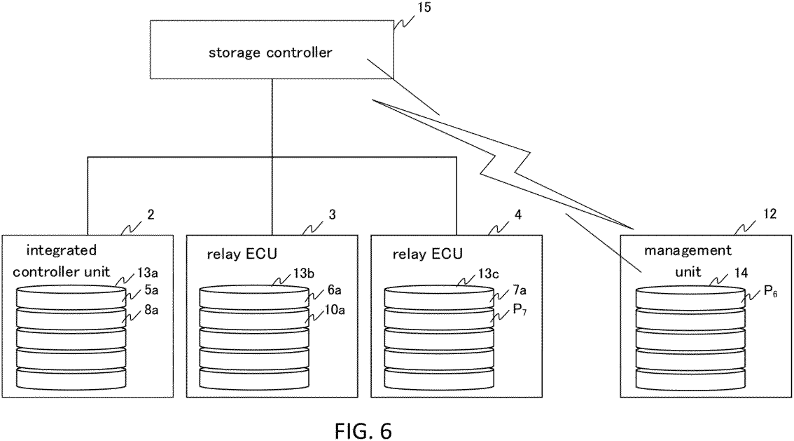

FIG. 6 shows a data storage technique of Example 3. While the storage locations for the parities are fixed in Example 2, the storage locations for the parities are sequentially changed by the storage controller 15 in Example 3. In Example 3, the whole information data 5a from the sensor 5 is written in the storage devices 13a, the whole information data 6a from the sensor 6 is written in the storage devices 13b, and the whole control signal data 7a for the actuator 7 is written in the storage devices 13c, as shown in FIG. 6. The parity P₆ generated by XORing the whole information data 5a from the sensor 5, the whole information data 6a from the sensor 6, and the whole control signal data 7a for the actuator 7 is written in the storage devices 14. Then, the whole control signal data 8a for the actuator 8 is written in the storage devices 13a, the whole control signal data 10a for the control ECU 10 is written in the storage devices 13b, and the parity P₇ generated by XORing the whole control signal data 8a for the actuator 8 and the whole control signal data 10a for the control ECU 10 is written in the storage devices 13c.

### Example 4

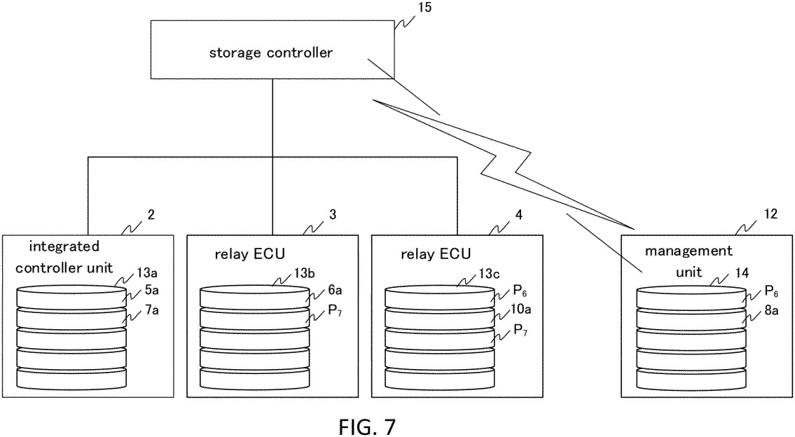

FIG. 7 shows a data storage technique of Example 4. While one storage location is assigned for each of the parities in Example 1 to Example 3, the parities are duplexed and separately written in two storage locations in Example 4. In Example 4, the whole information data 5a from the sensor 5 and the whole control signal data 7a for the actuator 7 are written in the storage devices 13a, and the whole information data 6a from the sensor 6 is written in the storage devices 13b as shown in FIG. 7. The parity P₆ generated by XORing the whole information data 5a from the sensor 5, the whole information data 6a from the sensor 6, and the whole control signal data 7a for the actuator 7 is written not only in the storage devices 14 but also in the storage devices 13c. Note that while the storage locations for the parity P₆ are assigned to the storage devices 14 and the storage devices 13c, the storage locations are not limited to this. So long as two of the storage devices are different, the storage locations may be any combination of the two. Likewise, the whole control signal data 8a for the actuator 8 is written in the storage devices 14 and the whole control signal data 10a for the control ECU 10 is written in the storage devices 13c, and the parity P₇ generated by XORing the whole control signal data 8a for the actuator 8 and the whole control signal data 10a for the control ECU 10 is written not only in the storage devices 13c but also in the storage devices 13b. Note that while the storage locations for the parity P₇ are assigned to the storage devices 13c and the storage devices 13b, the storage locations are not limited to this. So long as two of the storage devices are different, the storage locations may be any combination of the two. In addition, one of the parities P₆, P₇ each to be stored in two locations may be generated using a Reed-Solomon code.

In the in-vehicle network system 100 according to Embodiment 1, the data storage technique is set to any of those of Example 1 to Example 4. When the set storage technique is changed, the storage controller 15 cancels storage areas in the storage devices 13a, 13b, 13c and the storage devices 14 or changes them to different storage areas to assign anew areas for writing the data and the parities.

In setting a data storage technique among those of Examples 1 to 4, the storage areas for the information data from the sensors 5, 6 and the control signal data for the actuators 7, 8 and the control ECU 10 can be arbitrarily set. When the setting is changed through OTA (over the air), the storage controller 15 cancels the storage areas or change them to different storage areas to assign anew areas for writing the data and the parities.

In order to serve the in-vehicle network system as a data recorder, in a case of adding time information when an event occurs, the storage controller 15 allocates the time information as one data similarly to the information data from the sensors 5, 6 and the control signal data for the actuators 7, 8 and the relay ECU 10. The time information may be added by the sensor controller 15 or time information used for time synchronization of the backbone network may be utilized. Note that a known technique is used to detect an event. For example, thresholds may be set for the information from the sensors to detect an event.

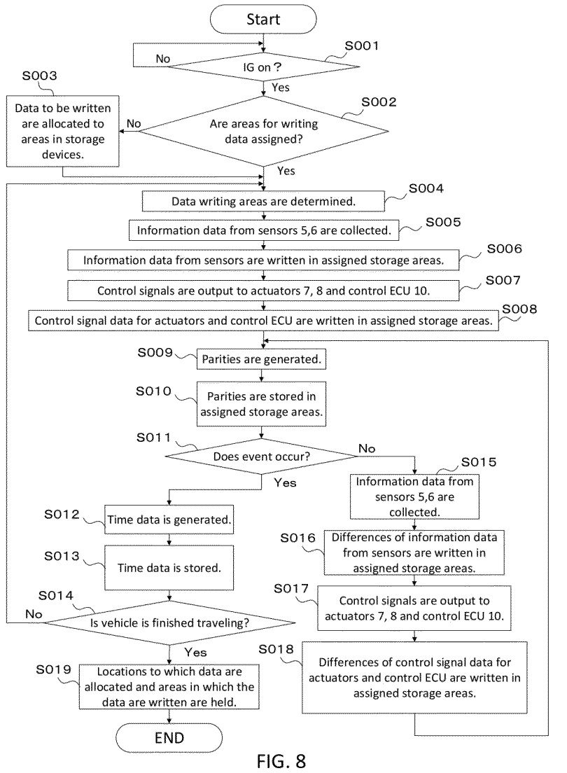

Next, a procedure for the in-vehicle network system 100 according to Embodiment 1 to operate as the data recorder is described with reference to FIG. 8. FIG. 8 is a flowchart showing the procedure of operating the in-vehicle network system 100 according to Embodiment 1 as the data recorder.

Firstly, a check is made whether the vehicle 1 is in an active state (an ignition-on state) (S001). When the vehicle 1 is active (“Yes” in S001), a check is made by the storage controller 15 whether areas for writing data are assigned to the storage devices 13a, 13b, 13c, and/or the storage devices 14 (S002). When the vehicle 1 is not active (“No” in S001), a wait is made until the vehicle 1 is activated.

If areas for writing data have been already assigned (“Yes” in S002), the areas for writing data are set (S004). If areas for writing data have been not yet assigned (“No” in S002), a data storage technique is arbitrarily selected among those of Example 1 to Example 4. After setting of the storage technique, the data to be written are allocated to areas in the storage devices 13a, 13b, 13c and/or the storage devices 14 by the storage controller 15 (S003).

In determining areas for writing data (S004), data is preferentially recorded in an unused area among reserved areas in the storage devices 13a, 13b, 13c and the storage devices 14; otherwise, data with no time information, in other words, data when no event occurs is deleted once to use the area in which the deleted data is recorded. If the storage devices 13a, 13b, 13c and the storage devices 14 do not satisfy the above criterion, stored data with the oldest time information is deleted once to use the area in which the deleted data is recorded.

After areas for writing data are determined, information data from the sensors 5, 6 are collected via the relay ECUs 2, 3 (S005). The collected data are written in the assigned storage areas by the storage controller 15 (S006). The information data from the sensors 5, 6 are input to the integrated controller unit 2 through the backbone communication line, and control signals are output to the actuators 7, 8 and the control ECU 10 by the integrated controller unit 2. The control signals are output through the backbone communication line via the relay ECUs 3, 4 (S007). The control signal data are written in the assigned storage areas through the backbone communication line (S008).

Furthermore, parities are generated by the storage controller 15 on the basis of the written information data from the sensors 5, 6 and the written control signal data for the actuators 7, 8 and the control ECU 10 (S009). The generated parities are stored in the assigned storage areas by the storage controller 15 (S010).

When an event occurs (“Yes” in S011), time data is generated (S012). The time data is stored in the area assigned beforehand by the storage controller 15 (S013). After finishing storing the time data, if the vehicle 1 is travelling (“No” in S014), then the procedure returns to S004.

When no event occurs (“No” in S011), information data from the sensors 5, 6 are collected via the relay ECUs 2, 3 (S015). The differences between the collected data and the last collected ones are extracted using the difference extraction functions 16 and are written in the storage areas beforehand assigned by the storage controller 15 (S016).

The collected information data in S015 are input to the integrated controller unit 2 and control signals are output to the actuators 7, 8 and the control ECU 10 by the integrated controller unit 2 (S017). In writing of the output control signal data, only differences from the last control signal data for the actuators 7, 8 and the control ECU 10 are extracted by the difference extraction functions 16, and the differences are written in the beforehand assigned storage areas by the storage controller 15 (S018). After the difference data are written, the procedure returns to S009.

When the vehicle 1 is stopping or parking (“Yes” in S014), the locations to which the data are allocated and the areas in which the data are written are held by the storage controller 15 (S019), and then the procedure ends.

As described above, the in-vehicle network system according to Embodiment 1 includes the sensors 5, 6 for acquiring information about the vehicle 1; the actuators 7, 8, 9 for controlling travel of and interior environment of the vehicle 1; the integrated controller unit 2 for outputting control signals for controlling the actuators 7, 8, 9 on the basis of the data of the information acquired by the sensors 5, 6; the storage devices 13a, 13b, 13c and the storage devices 14 for storing the data of the information acquired by the sensors 5, 6 and data of the control signals output from the integrated controller unit 2; the storage controller 15 for allocating and storing the data of the information acquired by the sensors 5, 6 and the data of the control signals output from the integrated controller unit 2 to and in the storage devices 13a, 13b, 13c and/or the storage devices 14, wherein the storage controller 15 generates parities corresponding to the allocated data and stores data of the parities in at least one of the storage devices. This enables implementation of a data recorder function without adding a new device and prevention of storage incapability due to a break of the network because the plurality of storage devices are distributed. Moreover, since the storage devices are distributed and the data are encoded, even if a failure occurs in the storage devices, lost information can be restored, thus being able to increase survivability of the stored data.

While the present application describes an exemplary embodiment and various examples, it should be understood that various features, aspects, and functionalities described in the embodiment are not limited in their applicability to the particular embodiment but instead can be applied alone or in various combinations to the embodiment. Therefore, numerous modifications that have not been exemplified are conceivable without departing from the technical scope disclosed in the specification of the present application. For example, at least one of the constituent components may be modified, added, or eliminated. Further at least one of the constituent components may be selected and combined with the other constituent elements.

### REFERENCE NUMERALS

1: vehicle;
2: integrated controller unit;
5, 6: sensor;
7, 8, 9: actuator;
13a, 13b, 13c, 14: storage devices;
15: storage controller; and
100: in-vehicle network system.

1. An in-vehicle network system comprising:
sensors configured to acquire information about a vehicle;
actuators configured to control travel of and interior environment of the vehicle;
a control indicator configured to output control signals for controlling the actuators on the basis of data of the vehicle information acquired by the sensors;
a plurality of storage devices configured to store the data of the vehicle information acquired by the sensors and data of the control signals output from the control indicator; and
a storage controller configured to allocate and stores the data of the vehicle information and the data of the control signals to and in the plurality of storage devices,
wherein the storage controller generates parities corresponding to the allocated data, and stores data of the parities in at least one of the storage devices.

2. The in-vehicle network system of claim 1, wherein one of the plurality of storage devices is provided in a management unit outside the vehicle, and the management unit is connected to the control indicator through telecommunication.

3. The in-vehicle network system of claim 1 , wherein one of the plurality of storage devices is provided in the control indicator.

4. The in-vehicle network system of claim 1, further comprising: a relay unit having one of the plurality of storage devices and provided between the sensors and the control indicator to gather the information acquires by the sensors.

5. The in-vehicle network system of claim 1, wherein in a case of a number of the plurality of storage devices being an integer n (n ≥ 3), the storage controller allocates and stores each of the data of the vehicle information and the data of the control signals to and in n-1 of the storage devices, and stores the data of the parities in one of the storage devices other than the n-1 storage devices.

6. The in-vehicle network system of claim 1, wherein in a case of a number of the plurality of storage devices being an integer n (n ≥ 3), the storage controller allocates and stores the data of the vehicle information and the data of the control signals to and in n-1 of the storage devices on a data item basis, and stores the data of the parities in one of the storage devices other than the n-1 storage devices.

7. The in-vehicle network system of claim 1, wherein the storage controller stores the data of the vehicle information, the data of the control signals, and the data of the parities sequentially in the plurality of storage devices.

8. The in-vehicle network system of claim 7, wherein the storage controller stores the same data of the parities in others of the storage devices than the storage devices storing the data of the parities.

9. The in-vehicle network system of claim 1, wherein the storage controller has a difference extraction function of extracting differences between the data of the vehicle information and data of newly acquired vehicle information and between the data of the control signals and data of newly acquired control signals, and allocates and stores the data of the differences to and in the plurality of the storage devices.

10. The in-vehicle network system of claim 2, wherein one of the plurality of storage devices is provided in the control indicator.

11. The in-vehicle network system of claim 2, further comprising: a relay unit having one of the plurality of storage devices and provided between the sensors and the control indicator to gather the information acquires by the sensors.

12. The in-vehicle network system of claim 3, further comprising: a relay unit having one of the plurality of storage devices and provided between the sensors and the control indicator to gather the information acquires by the sensors.

13. The in-vehicle network system of claim 10, further comprising: a relay unit having one of the plurality of storage devices and provided between the sensors and the control indicator to gather the information acquires by the sensors.

14. The in-vehicle network system of claim 2, wherein in a case of a number of the plurality of storage devices being an integer n (n ≥ 3), the storage controller allocates and stores each of the data of the vehicle information and the data of the control signals to and in n-1 of the storage devices, and stores the data of the parities in one of the storage devices other than the n-1 storage devices.

15. The in-vehicle network system of claim 3, wherein in a case of a number of the plurality of storage devices being an integer n (n ≥ 3), the storage controller allocates and stores each of the data of the vehicle information and the data of the control signals to and in n-1 of the storage devices, and stores the data of the parities in one of the storage devices other than the n-1 storage devices.

16. The in-vehicle network system of claim 10, wherein in a case of a number of the plurality of storage devices being an integer n (n ≥ 3), the storage controller allocates and stores each of the data of the vehicle information and the data of the control signals to and in n-1 of the storage devices, and stores the data of the parities in one of the storage devices other than the n-1 storage devices.

17. The in-vehicle network system of claim 2, wherein in a case of a number of the plurality of storage devices being an integer n (n ≥ 3), the storage controller allocates and stores the data of the vehicle information and the data of the control signals to and in n-1 of the storage devices on a data item basis, and stores the data of the parities in one of the storage devices other than the n-1 storage devices.

18. The in-vehicle network system of claim 3, wherein in a case of a number of the plurality of storage devices being an integer n (n ≥ 3), the storage controller allocates and stores the data of the vehicle information and the data of the control signals to and in n-1 of the storage devices on a data item basis, and stores the data of the parities in one of the storage devices other than the n-1 storage devices.

19. The in-vehicle network system of claim 10, wherein in a case of a number of the plurality of storage devices being an integer n (n ≥ 3), the storage controller allocates and stores the data of the vehicle information and the data of the control signals to and in n-1 of the storage devices on a data item basis, and stores the data of the parities in one of the storage devices other than the n-1 storage devices.
